(19) United States
(12) Patent Application Publication
(10) Pub. No.: US 2025/0128354 A1
(43) Pub. Date: Apr. 24, 2025

(54) LASER AND FOIL BASED ADDITIVE MANUFACTURING SYSTEM AND METHODS

(71) Applicant: IPG PHOTONICS CORPORATION, Marlborough, MA (US)

(72) Inventor: Igor SAMARTSEV, Westborough, MA (US)

(73) Assignee: IPG PHOTONICS CORPORATION, Marlborough, MA (US)

(21) Appl. No.: 18/833,100

(22) PCT Filed: Jan. 30, 2023
(86) PCT No.: PCT/US23/11842

§ 371 Date: Jul. 25, 2024

Related U.S. Application Data
(60) Provisional application No. 63/305,768, filed on Feb. 2, 2022.

(51) Int. Cl. B23K 26/342; B23K 26/08; B23K 26/12; B33Y 10/00; B33Y 30/00

(52) U.S. Cl. CPC B23K 26/342; B23K 26/0846; B23K 26/123; B33Y 10/00; B33Y 30/00

(57) ABSTRACT

A method and system for additive manufacturing is disclosed. In one example, the method comprises (a) positioning a foil layer onto a substrate, (b) laser welding the foil layer to the substrate, (c) laser ablating the foil layer using a pulsed laser beam to remove at least a portion of the foil layer, the pulsed laser beam comprising optical pulses with a pulse duration in a range from 0.5 ps to 10 ps inclusive, and (d) repeating steps (a) to (c) until the 3D component is completed.

### RELATED APPLICATIONS

The present application is a 371 application of PCT/US2023/011842 filed on Jan. 30, 2023 which claims priority to U.S. Provisional Application Ser. No. 63/305,768 filed on Feb. 2, 2022, titled “LASER AND FOIL BASED ADDITIVE MANUFACTURING SYSTEM AND METHOD,” the content of which is herein incorporated by reference in its entirety.

### BACKGROUND

### Technical Field

The technical field relates generally to additive manufacturing, and more specifically to using laser energy to treat successive foil layers in an additive manufacturing process.

### Background Discussion

Additive manufacturing (AM) processes have evolved into an entirely new industry for producing three-dimensional (3D) solid objects by adding individual layers of material. Two AM processes that employ the use of lasers include LMD (Laser Metal Deposition) and Selective Laser Melting (SLM). Another laser technique is known as stereolithography (SLA) that uses shorter wavelength lasers to locally photopolymerize a liquid. All of these techniques use a bed of powder that is refreshed after each layer is laser fused. Another laser technique is known as Laser Metal Deposition (LMD). In this case, a powder is fed co-axially through a nozzle into the focused laser spot and fully dense functional metallic components are produced.

Powder-based AM processes have a number of shortcomings. For one thing, these processes are slow, e.g., taking many hours or days to complete a component, and therefore are used for short or single runs of unique components. One of the reasons powder AM processes are slow is because the part needs additional processing (i.e., post-processing procedures) beyond the initial laser sintering. Metal powder is also expensive and is not easily recycled. There is therefore a need for AM process systems that are capable of quickly and inexpensively producing high volumes of 3D components.

### SUMMARY

Aspects and embodiments are directed to a method and system for additive manufacturing of 3D components.

In accordance with an exemplary embodiment, there is provided a method for AM of a three-dimensional (3D) component. The method comprises (a) positioning a foil layer onto a substrate, (b) laser welding the foil layer to the substrate, (c) laser ablating the foil layer using a pulsed laser beam to remove at least a portion of the foil layer, the pulsed laser beam comprising optical pulses with a pulse duration in a range from 0.5 picoseconds (ps) to 10 ps inclusive, and (d) repeating steps (a) to (c) until the 3D component is completed.

In one example, the optical pulses have a pulse energy from 25 microJoules (μJ) to 200 (μJ) inclusive.

In one example, each pulse of the pulsed laser beam has a peak power of at least 1 megawatt (MW).

In one example, laser welding is performed using a laser beam obtained from at least one of a continuous-wave (CW) laser source and a quasi-continuous wave (QCW) laser source, and the method further comprises providing at least one of the CW and QCW laser sources. In a further example, at least one of the CW and QCW laser sources is configured to have an output power of at least 1 kW. In a further example, at least one of the CW and QCW laser sources is configured to have an output power of at least 5 kW.

In one example, the method further includes receiving the foil layer, and the foil layer is wound into a roll of foil material. In a further example, the foil layer is up to 1 millimeter (mm) inclusive in thickness. In a further example, the foil layer comprises a metal material. In a further example, the laser welding and laser ablating is performed in a processing region and the method further comprises unrolling the foil layer in one direction from the roll and guiding the foil layer to the processing region.

In one example, the method further includes lowering a build platform that supports the substrate by moving the build platform in a z-axis direction prior to step (a), the z-axis direction being oriented in a plane orthogonal to the build platform.

In one example, welding is performed in a z-axis direction and laser ablating is performed in x-axis and y-axis directions.

In one example, the method further includes performing the laser welding and laser ablating in an atmosphere controlled build chamber that is configured to at least partially contain an inert gas.

In one example, the laser welding and laser ablating is performed in a processing region and the method further comprises directing an inert gas to the processing region.

In accordance with another exemplary embodiment, an AM system for forming a 3D component from a plurality of successive foil layers is provided. The AM system includes a welding laser configured to generate a laser beam capable of welding a foil layer onto a substrate, an ablating laser configured to generate a pulsed laser beam capable of removing at least a portion of the foil layer, the pulsed laser beam comprising optical pulses having a pulse duration in a range from 0.5 ps to 10 ps inclusive, and a controller configured to: receive build instructions regarding each foil layer used to successively build the 3D component, the build instructions including welding energy information and ablating energy information for each foil layer, and send control signals to each of the welding laser and the ablating laser such that the welding laser provides welding laser energy corresponding to the welding energy information and the ablating laser provides ablating laser energy corresponding to the ablating energy information for each foil layer.

In one example, the build instructions include at least one of x-, y-, and z-positional data associated with each of the welding energy information and the ablating energy information, and the controller is further configured to control at least one of a position of the welding laser and a position of the ablating laser in at least one of x-, y-, and z-axis directions based on the x-, y-, and z-positional data.

In one example, the controller is further configured to control a foil delivery system, the foil delivery system configured to guide the foil layer to a processing region.

In one example, the foil layer is wound into a roll of foil material and the foil delivery system is further configured to unroll the foil layer in one direction from the roll.

In one example, the welding laser is configured to weld in a z-axis direction that is oriented in a plane orthogonal to the processing region.

In one example, the AM system further includes an inert gas directed at the processing region.

In one example, the ablating laser is configured to remove foil layer material in at least one of the x-axis and y-axis directions.

In one example, the welding laser is configured to have an output power of at least 1 kW. In a further example, the welding laser is configured to have an output power of at least 5 kW.

In one example, the welding laser includes at least one of a continuous-wave (CW) laser source and a quasi-continuous wave (QCW) laser source.

In one example, the ablating laser is configured such that each pulse of the pulsed laser beam has a peak power of at least 1 megawatt (MW).

In one example, at least one of the welding laser and the ablating laser is configured as a fiber laser.

In one example, the AM system further includes an atmosphere controlled build chamber that is configured to at least partially contain an inert gas and surround the welding and ablating laser beams.

In one example, the foil material is a metal material having a thickness up to 1 mm.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of one example of an additive manufacturing (AM) system in accordance with aspects of the invention;

FIG. 2A is a block diagram of one example of a welding treatment to a foil layer using a laser of the AM system of FIG. 1;

FIG. 2B is a block diagram of one example of an ablating treatment to the foil layer of FIG. 2A using a laser of the AM system of FIG. 1;

FIG. 3 is a schematic representation of the progressive build process of each foil layer successively added to build the 3D component in accordance with aspects of the invention;

FIG. 4 is a block diagram of one example of a 3D component being constructed by two lasers of the AM system of FIG. 1;

FIG. 5 is a schematic representation of one example of an advancing layer of foil material in a continuous process in accordance with aspects of the invention;

FIG. 6 is a schematic representation of another example of an advancing layer of foil material in a continuous process in accordance with aspects of the invention; and

FIG. 7 is a flow chart illustrating the steps and decision block of a method for additive manufacturing in accordance with aspects of the invention.

### DETAILED DESCRIPTION

As previously mentioned, cost and throughput are two of the biggest problems associated with powder-based AM processes and systems. Powder-based systems are conventionally used for modeling and low volume applications, such as in aviation and the medical industries. Disclosed herein are foil-based AM systems and methods that implement the use of lasers that address many of the problems associated with powder-based AM processes. The disclosed systems and methods are significantly faster, e.g., 100× faster than powder-based AM systems and are capable of being implemented in continuous, large volume manufacturing applications. In addition, the foil-based AM technique does not require post-processing procedures as is the case with powder-based AM techniques. As described in more detail below, foil layers are successively added to a substrate and each foil layers is exposed to two separate laser treatments. A first laser treatment(s) welds the foil material, and a second laser treatment ablates the foil material. In contrast to powder-based AM processes, the foil material is cheaper and much easier to recycle than powder materials. In addition, 3D components having low weights and/or porous structures are possible to construct using foil layers, which is not necessarily the case with powder material. Foil material is also safer to use than powder, since the latter is typically microscopic in size (<100 μm) and often poses toxicity, reactivity, combustibility, and instability hazards.

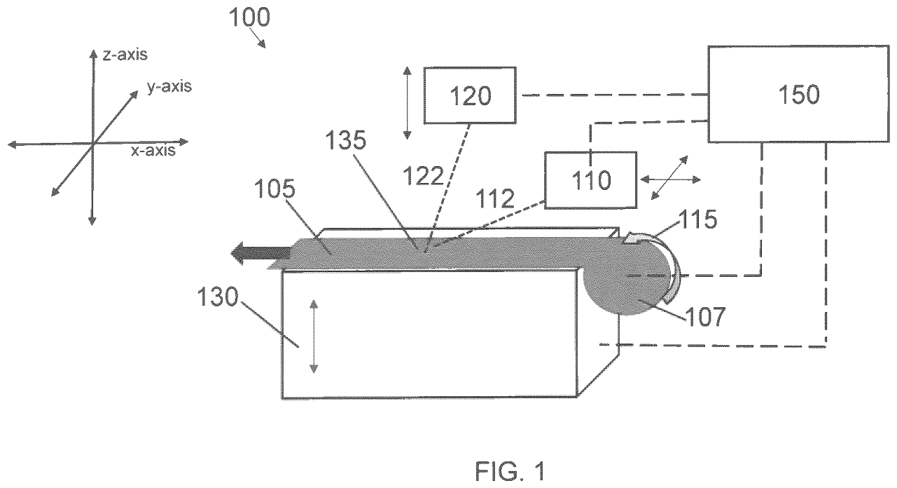

Referring to FIG. 1, a block diagram of one non-limiting example of an AM system, generally shown at 100, is shown. AM system 100 comprises a welding laser 120, an ablating laser 110, and a controller 150.

The welding laser 120 is configured to generate a laser beam 122 (also referred to herein as a welding laser beam) that is capable of welding a foil layer 105 onto a substrate 132. In some embodiments, the substrate 132 is positioned on a build platform 130. It is to be appreciated that according to some embodiments the substrate 132 is a previous foil layer, and in some instances (e.g., at the start of the AM process) the substrate 132 may be a 2D or 3D build substrate that is later removed.

As used herein, the term foil layer refers to a thin and flexible film or sheet of any material having, for example, about 10 microns (μm) to about 1 mm in thickness, although thicker materials are within the scope of this disclosure. In some embodiments, the foil layer is up to 1 millimeter (mm) inclusive in thickness. It is to be appreciated that the foil layer may have any thickness that is capable of undergoing the disclosed process to construct a desired 3D component. According to some embodiments, the foil layer comprises a metal material. Non-limiting examples of metal materials that are suitable for the disclosed AM systems and processes include aluminum, steel and steel alloys, nickel, titanium, copper, tin, cobalt, niobium, tantalum, Inconel, and other metal materials and any alloy. According to other embodiments, the foil layer comprises a polymer material. Non-limiting examples of polymers that may be suitable for the disclosed methods and systems include polypropylenes, polyethylenes, polystyrene, polyvinyl alcohol, polyester, polyimides, and other polymer-based materials. Other materials and composite materials are also within the scope of this disclosure.

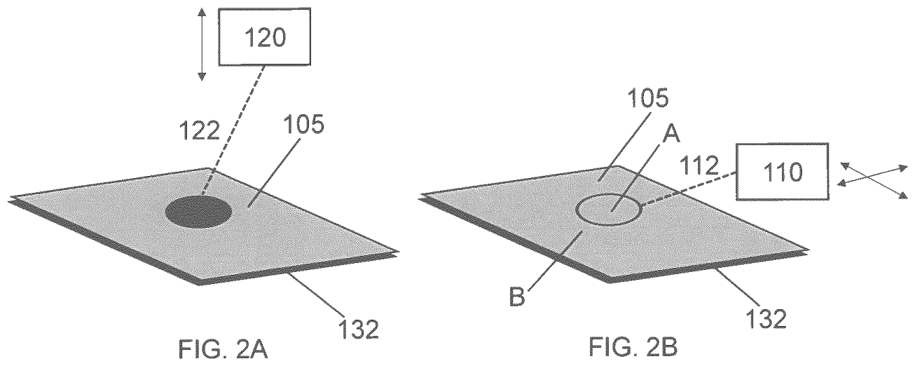

Welling the foil layer 105 using the welding laser 120 (also referred to as a welding laser source) functions to attach the foil layer 105 to the underlying substrate 132. A schematic representation of one example of this process is shown in FIG. 2A. The laser beam 122 of the welding laser 120 is directed to the surface of the foil layer 105 and applies enough laser energy to weld foil layer 105 to underlying substrate 132 (in this instance substrate 132 is a previous foil layer). The welded region in FIG. 2A is shown as a dark circle. According to some embodiments, the welding laser 120 is configured to have an output power of at least 1 kilowatt (kW), and in some embodiments has an output power of at least 5 kW, and in still other embodiments has an output power in a range of 5-10 kW inclusive. Output powers of less than 1 kW are also within the scope of this disclosure, since in certain applications a lower welding power may be required or desired.

In at least one embodiment, laser welding is performed using a laser beam obtained from at least one of a continuous-wave (CW) laser and a quasi-continuous wave (QCW) laser source. According to one embodiment, the CW laser is configured to generate a single mode (SM) laser beam having a spot size in a range down to 10 μm, although smaller spot sizes can be achieved by having a focal length of less than 200 mm. Quasi-continuous wave (QCW) lasers feature a switched pump source that is switched on for short enough time periods to reduce thermal effects, while also remaining switched on for long enough periods to maintain a continuous-wave output. QCW laser are configured with increased numbers of pump diodes that are spliced into the active fiber. A low duty cycle (e.g., 1-15% inclusive) is implemented, which requires a smaller power supply but in pulsed mode the laser provides up to 10× higher peak power as compared to the output power in CW mode. For example, a CW laser may be configured to have an average output power of 600 Watts (W), and the QCW laser may be configured to have a peak power of 6000 W. In essence, the QCW provides high peak power for short duty cycles. QCW lasers can be configured to provide multiple Joules of pulse energy at multi-kW peak powers, with microsecond (μs) to millisecond (ms) pulse duration. The CW and QCW lasers can be used to perform different types of welding operations. For instance, QCW lasers can be modulated to minimize heat input, i.e., reduced heat input, to the component during laser processing. QCW lasers may be particular useful for applications that require a high peak power and pulse energy in a long pulse regime, such as spot welding and seam welding. Examples of suitable CW and QCW welding lasers can be obtained from IPG Photonics of Oxford, Massachusetts, USA.

According to some embodiments, welding of the foil layer 108 can be performed in multiple steps, and in some instances, welding can be done using multiple welding lasers or a single laser that can be configured to operate in different modes. In one embodiment, a first welding laser can be configured to generate a laser beam suitable for performing bulk welding operations using high power and large spot sizes. Bulk welding can be used to quickly weld larger surface areas. A second welding laser can be used to perform precision welding. Precision welding can be done on areas that require more precision (e.g., corners, edges of topographies). The output power and spot size of the laser beam used for each type of welding application can be different from one another, and will be dependent on the material and configuration of the 3D components. In terms of timing, either type of welding can be performed before the other or simultaneously, depending on the application and laser configuration. For instance, in some embodiments spot welding may be performed first and then a different type of welding can be performed second.

The ablating laser 110 is configured to generate a pulsed laser beam 112 (also referred to as an ablating laser beam) that is capable of removing at least a portion of the foil layer 105. The pulsed laser beam 112 comprises optical pulses that have a pulse duration in a range from 0.5 ps to 10 ps inclusive. According to one embodiment, the optical pulses have a pulse duration of 1 ps. In some embodiments, the optical pulses have a pulse duration of 1-3 ps inclusive and a pulse frequency in a range of 50-2000 kHz inclusive. Turning now to FIG. 2B, a schematic representation of one example of an ablating process is shown. The laser beam 112 of the ablating laser 110 is directed to the surface of the foil layer 105 and applies enough laser energy to remove at least a portion of the foil layer 108, which is shown in FIG. 2B as a dark ring. The ablating laser energy is absorbed by the foil material and evaporates, vaporizes, or sublimates. In the example of FIG. 2B, the center region of the dark ring was previously welded using welding laser 120 in FIG. 2A (labeled as region “A”). After ablation, the foil material outside the dark ring (labeled as region “B”) separates from welded region “A.” Region “B” can then be removed from the vicinity of the work area that is associated with region “A,” (e.g., sent to be recycled).

There are two broad classes of laser ablation: thermal and athermal. Thermal ablation is dependent of thermal effects, such as melting, and is not the type of ablation induced by the ablating laser 110 as described herein. Athermal ablation can occur when an ultra-short pulse is focused on a material as a result of the high electric fields associated with the ultra-short pulse, and is the type of ablation induced by the ablating laser 110. Material removal induced or otherwise created by athermal ablation has several advantages when compared to other conventional methods of material removal, such as mechanical machining. For one thing, athermal ablation permits more accurate removal of material without mechanically damaging the surrounding material. Pulses longer than ps-levels (e.g., >1 ns) and laser energy sourced from CW lasers also damage the surrounding materials. Examples of suitable ablating lasers can be obtained from IPG Photonics of Oxford, Massachusetts, USA.

Besides removing material, the ablating laser 110 may be used to perform surface treatments/functionalization on the foil layer, such as texturing, patterning, etc. This is an additional advantage over powder-based AM systems, since such a high-precision technique cannot be applied without an additional piece of equipment.

In accordance with at least one embodiment, optical pulses of the pulsed laser beam 112 have a pulse energy from 25 microJoules (μJ) to 200 (μJ) inclusive. According to another embodiment, each pulse of the pulsed laser beam 112 has a peak power of at least 1 megawatt (MW). In some embodiments, the peak power can be in a range of 25-50 MW. For instance, according to one non-limiting example, the optical pulses have a duration of 1 ps, a pulse energy of 25 μJ, and a peak power of 25 MW.

According to some embodiments, at least one of the welding laser 120 and the ablating laser 110 is configured as a fiber laser. A fiber laser refers to a laser with a doped fiber as the gain medium, but can also refer to a laser where most of the laser resonator is made of optical fiber.

Returning now to FIG. 1, in accordance with at least one aspect, the foil layer 105 is wound into a roll of foil material 107. The roll of foil material 107 can be guided or otherwise directed to the substrate 132 and/or processing region 135 (where at least one of laser welding or laser ablating energy is being applied to the foil layer 105) using a foil delivery system, shown generally as 115 in FIG. 1. In some embodiments, the foil delivery system guides the foil material to the build platform 130, which functions to support the substrate 132. The foil layer 105 is unrolled in one direction from the roll 107 by the foil delivery system 115. In some embodiments, the foil layer 105 is guided along the build platform 130.

The foil layer 105 is processed by welding laser 120 and ablating laser 110 as it is conveyed to the substrate 132 and/or processing region 135. The roll of foil material 107 is fed or otherwise guided to the substrate 132 and/or processing region 135 such that successive layers of the foil material are laser treated to form a 3D component. In accordance with some embodiments, the foil delivery system 115 is configured to guide the foil layer 105 to the substrate 132 and/or processing region 135 in at least one of the x-axis and y-axis directions. FIG. 1 includes a reference coordinate system, which comprises three orthogonal axes which include a longitudinal or x-axis, a lateral or y-axis, and a vertical or z-axis. In the 30 example of FIG. 1, the roll of foil material 107 is directed in the x-axis direction.

AM system 100 also comprises a controller 150, as shown in FIG. 1. In accordance with at least one embodiment, the controller 150 is configured to receive build instructions regarding each foil layer 105 used to successively build the 3D component. The build instructions include welding energy information and ablating energy information for each foil layer. For example, the welding energy information includes the required laser energy (given the welding laser configuration) for welding the foil layer 105 to the underlying substrate and the ablating energy information includes the required laser energy (given the ablating laser configuration) for ablating the foil layer 105. This energy information is used by the controller 150 to send control signals to each of the welding laser 120 and the ablating laser 110 such that each laser provides the desired laser energy to each foil layer 105.

The build instructions may also include at least one of x-, y-, and z-positional data associated with each of the welding energy information and the ablation energy information for each layer. For example, the build instructions for foil layer n will include at least one of x-, y-, and z-positional data associated with the required welding energy information. This is so that the laser beam 122 from the welding laser 120 applies the desired welding energy to the correct geographical position on the foil layer 105. It is to be appreciated that the welding information may be a constant welding laser energy value, meaning that the welding laser is powered on or off, as compared to being modulated or changed with respect to position. The controller 150 sends a control signal to the welding laser 120 to generate and provide or otherwise direct welding laser energy to a position on the foil layer 105. For example, the welding laser 120 may be controlled by the controller 150 to apply a 2 kW laser beam to position x1 and y1 on the foil layer 105.

In some instances, the welding laser 120 is configured with x-, y-, and/or z-axis direction movement capability and the controller 150 will send control signals with the positional data to the welding laser 120 (e.g., a device or structure that moves the welding laser in at least one of these coordinates). In other instances, the build platform 130 is configured with at least one of x-, y-, and z-direction movement capabilities so that the foil layer 105 underneath the welding laser 120 is moved to the desired position to receive the prescribed welding laser energy from the welding laser beam 122. In this latter case with the moveable build platform 130, the controller 150 will also send control signals to the build platform 130 that direct the build platform 130 to the correct position.

A similar process with the build instructions for foil layer n is also used for the ablating energy information. The controller 150 sends a control signal to the ablating laser 110 to generate and direct the desired ablating laser energy to a position on the foil layer 105. As with the welding laser 120, either the ablating laser 110 or the build platform 130 is equipped with x-, y-, and/or z-axis direction movement capability and the controller 150 will send control signals with positional data to one of these devices.

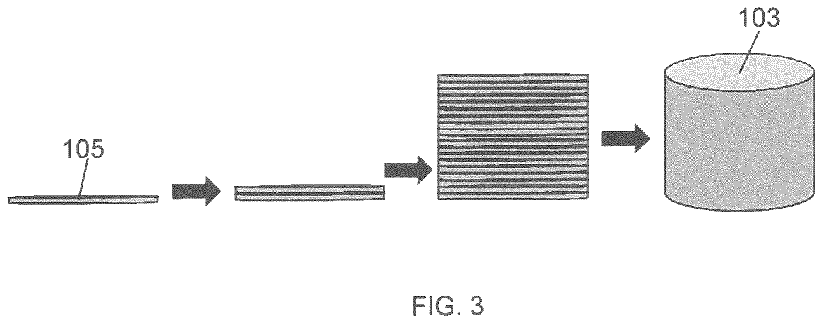

FIG. 3 is a schematic representation of the progressive build process of each foil layer 105 as it is successively added to build the 3D component 103. On the far left, the process begins with a single foil layer 105. To this, multiple foil layers are added sequentially on top of one another (i.e., moving in the direction of the arrow to the right as indicated in FIG. 3), with each layer receiving welding and ablating laser energy to shape it to the desired layer geometry. Foil layers are added until the desired 3D component 103 is formed and the process is complete. According to some embodiments, the build platform 130 can be moved in a z-axis direction (i.e., lowered) prior to positioning a “fresh” layer of foil material onto the substrate.

Control of AM system 100 is accomplished with controller 150. The controller 150 is configured in various examples as a microprocessor implemented computer system having software and hardware control modules. As indicated in FIG. 1, controller 150 is coupled to or otherwise in communication with the welding laser 120, the ablating laser 110, the foil delivery system 115, and the build platform 130, and may also be coupled to movement apparatuses for each of laser 110 and 120, as mentioned previously. The controller 150 is configured with the ability to receive the build instructions (e.g., stored internally or sent externally), which is a digital file that includes the details of the design of the multilayer 3D component allowing sequential build up using the welding and ablating laser processes with foil layer geometry and processing parameters.

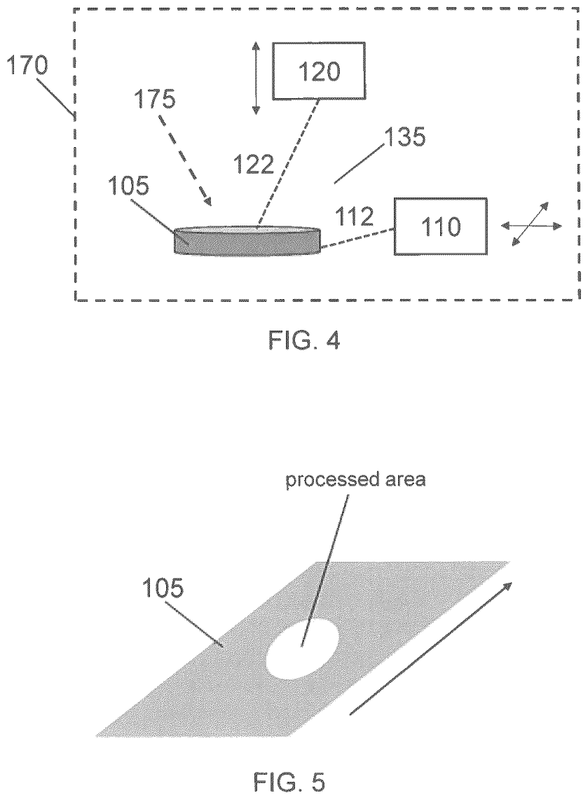

In accordance with at least one embodiment, laser welding is performed in the z-axis direction and laser ablating is performed in x-axis and y-axis directions. This can be shown in the schematic representation of FIG. 4. Welding laser 120 is configured to direct welding laser energy via welding laser beam 122 in the z-axis direction, and in some instances is configured to move in the z-axis direction as indicated in FIG. 4. It is to be appreciated that the welding laser 120 may also be configured to move in at least one of the x-axis and y-axis directions. Ablating laser 110 is configured to direct ablating laser energy via ablating laser beam 112 in at least one of the x-axis and y-axis directions, and as indicated in FIG. 4, in some embodiments is configured to move in the x-axis and y-axis directions. It is to be appreciated that ablating laser 110 may also be configured to move in the z-axis direction, and in some instances at least one of welding laser 120 and ablating laser 110 are capable of rotational movement. In addition, one or both of lasers 110 and 120 may be configured with a scanning device as known in the art. Using the lasers in the configuration as described in FIG. 4 has several benefits, including a speedy process. In one aspect, the process is sped up due to the use of two separate lasers that are each dedicated to perform different processing techniques. In another instance, x- and y-direction treatment by the ablating laser 110 allows for removed material to fall away using gravity.

According to certain embodiments, laser welding and ablating are performed in the presence of an inert gas. For example, an atmosphere controlled build chamber 170 (e.g., see FIG. 4) can be configured to at least partially contain an inert gas and surround the welding and ablating laser beams 122 and 112 and the processing region 135. The inert gas can be nitrogen or argon or any other inert gas suitable for the AM processes described herein. In some embodiments, the atmosphere controlled build chamber 170 may be an air-tight chamber with a processing window (not shown) to allow at least a portion of laser beams 112 and 122 to pass into the chamber 170. The chamber 170 may be atmospherically controlled to reduce oxidation effects when performing welding and ablating of the foil layer. A vacuum system (not shown) may also be used to remove oxygen from the chamber 170 and a gas system (not shown) may supply an inert gas to the chamber 170. According to another example, the inert gas 175 can be directed at the processing region 135 in much the same way as a shielding gas is directed at welding and/or ablating operation, as appreciated by those skilled in the art. In such instances, a nozzle or other gas delivery device may be used. In both instances, the inert/shield gas functions to protect surfaces from oxidation, especially in instances where the foil layer material is one that readily oxidizes in the presence of oxygen (e.g., metals).

In some embodiments, the AM system is configured to operate continuously or quasi-continuously, in a conveyor-like manner. This can be achieved in a number of different ways. A first example is shown in FIG. 5 and is accomplished by keeping enough material surrounding the processed area (i.e., portion or region of the foil layer that receives laser treatment) intact such that the roll of foil material can be advanced, as indicated by the arrow in FIG. 5. The build platform 130 (not shown in FIG. 5) can be lowered after each foil layer is laser treated, which also lowers the previously processed area. The foil layer is then advanced and “covers” the previously processed area. This “fresh” processed area is then ready to be laser treated.

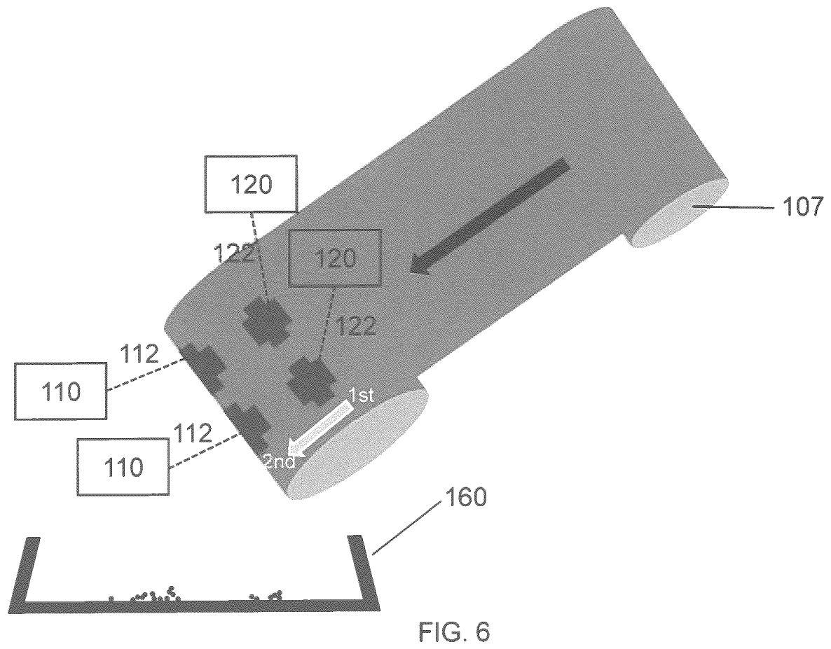

A second non-limiting example of an AM system configured to operate continuously is shown in FIG. 6. A roll of foil material 107 is rolled in one direction and is treated by a welding laser 120 first, and then an ablating laser 110 second, as indicated. In this instance, the foil layer 105 is unrolled off the roll 107 and guided or otherwise directed in the direction of the dark arrow as indicated in FIG. 6. The foil layer 105 is exposed to welding laser energy from welding laser beam 122 generated from welding laser 120 and then wound around in a roll-like manner to be ablated by ablating laser beam 112 generated by ablating laser 110. The welding laser energy is directed in a z-axis direction, and the ablating laser energy is directed in an x- and y-axis direction, as shown. Once ablated, unwanted material falls away (via gravity and/or pressurized gas applied to the processed area) to a waste collection device 160, where it may be recycled. The processed area then rotates back upward again to the vicinity of the welding laser beam 122, where it is covered by a fresh layer of foil material sourced from roll 107 and the process repeats itself until the 3D component is complete. In this embodiment, the “build platform” is cylindrical in shape and with each rotation welding and ablating occurs and the 3D component is built up layer by layer. According to some embodiments, and as shown in FIG. 6, multiple 3D components can be processed simultaneously using arrays of welding and ablating lasers. During processing, the movement of the foil layer 105 into the processing region may be halted or slowed so that the foil material can be exposed to the required laser energy. In other embodiments, the foil layer 105 moves in a continuous fashion.

In accordance with some embodiments, individual sheets of foil material can be sequentially positioned on the build platform and/or substrate and individually processed.

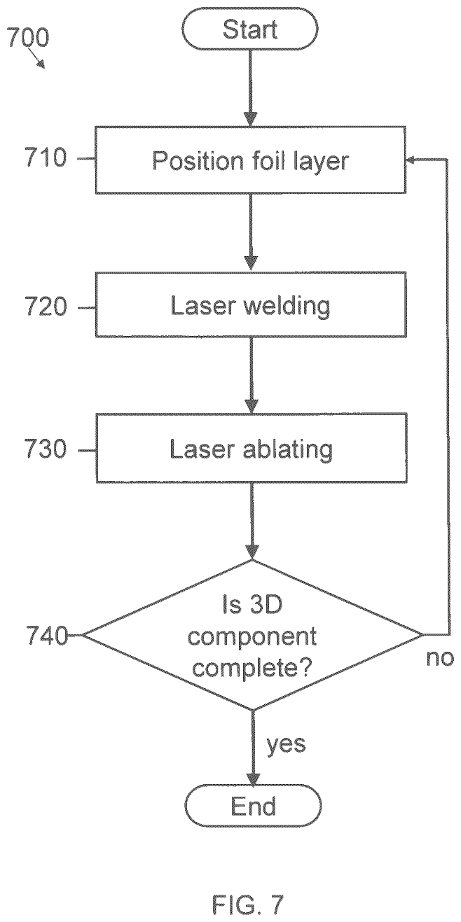

Referring to FIG. 7, an exemplary method 700 for additive manufacturing is described. Initially, at step 710 of the method 700, a foil layer is put into position. This is intended to be an unprocessed “fresh” layer of foil material that is positioned such that it can be exposed to welding and/or ablating laser energy. At step 720, laser welding is performed on the foil layer as previously described, and at step 730, laser ablation is performed on the foil layer, as previously described. A decision is made at step 740, i.e., by controller 150 as to whether the 3D component is complete, i.e., has the sequence of build instructions been completed. If yes, the process ends. If no, the process returns to step 710, where the next foil layer in the sequence is processed through steps 710, 720, and 730.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of at least one example, it is to be appreciated that various alterations. modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A method for additive manufacturing (AM) of a three-dimensional (3D) component, comprising:
(a) positioning a foil layer onto a substrate;
(b) laser welding the foil layer to the substrate;
(c) laser ablating the foil layer using a pulsed laser beam to remove at least a portion of the foil layer, the pulsed laser beam comprising optical pulses with a pulse duration in a range from 0.5 picoseconds (ps) to 10 ps inclusive; and
(d) repeating steps (a) to (c) until the 3D component is completed.

2. The method of claim 1, wherein the optical pulses have a pulse energy from 25 microJoules (μJ) to 200 (μJ) inclusive.

3. The method of claim 1, wherein each pulse of the pulsed laser beam has a peak power of at least 1 megawatt (MW).

4. The method of claim 1, wherein laser welding is performed using a laser beam obtained from at least one of a continuous-wave (CW) laser source and a quasi-continuous wave (QCW) laser source, and the method further comprises providing at least one of the CW and QCW laser sources.

5. The method of claim 4, wherein at least one of the CW and QCW laser sources is configured to have an output power of at least 1 kW.

6. (canceled)

7. The method of claim 1, further comprising receiving the foil layer, and the foil layer is wound into a roll of foil material.

8-9. (canceled)

10. The method of claim 7, wherein the laser welding and laser ablating is performed in a processing region and the method further comprises unrolling the foil layer in one direction from the roll and guiding the foil layer to the processing region.

11. The method of claim 1, the method further comprising lowering a build platform that supports the substrate by moving the build platform in a z-axis direction prior to step (a), the z-axis direction being oriented in a plane orthogonal to the build platform.

12. The method of claim 1, wherein welding is performed in a z-axis direction and laser ablating is performed in x-axis and y-axis directions.

13-14. (canceled)

15. An additive manufacturing (AM) system for forming a 3D component from a plurality of successive foil layers, the AM system comprising:
a welding laser configured to generate a laser beam capable of welding a foil layer onto a substrate;
an ablating laser configured to generate a pulsed laser beam capable of removing at least a portion of the foil layer, the pulsed laser beam comprising optical pulses having a pulse duration in a range from 0.5 ps to 10 ps inclusive; and
a controller configured to:
receive build instructions regarding each foil layer used to successively build the 3D component, the build instructions including welding energy information and ablating energy information for each foil layer, and
send control signals to each of the welding laser and the ablating laser such that the welding laser provides welding laser energy corresponding to the welding energy information and the ablating laser provides ablating laser energy corresponding to the ablating energy information for each foil layer.

16. The AM system of claim 15, wherein the build instructions include at least one of x-, y-, and z-positional data associated with each of the welding energy information and the ablating energy information, and the controller is further configured to control at least one of a position of the welding laser and a position of the ablating laser in at least one of x-, y-, and z-axis directions based on the x-, y-, and z-positional data.

17. The AM system of claim 16, wherein the controller is further configured to control a foil delivery system, the foil delivery system configured to guide the foil layer to a processing region.

18. The AM system of claim 17, wherein the foil layer is wound into a roll of foil material and the foil delivery system is further configured to unroll the foil layer in one direction from the roll.

19. The AM system of claim 17, wherein the welding laser is configured to weld in a z-axis direction that is oriented in a plane orthogonal to the processing region.

20. (canceled)

21. The AM system of claim 16, wherein the ablating laser is configured to remove foil layer material in at least one of the x-axis and y-axis directions.

22. The AM system of claim 15, wherein the welding laser is configured to have an output power of at least 1 kW.

23. (canceled)

24. The AM system of claim 15, wherein the welding laser includes at least one of a continuous-wave (CW) laser source and a quasi-continuous wave (QCW) laser source.

25. The AM system of claim 15, wherein the ablating laser is configured such that each pulse of the pulsed laser beam has a peak power of at least 1 megawatt (MW).

26. The AM system of claim 15, wherein at least one of the welding laser and the ablating laser is configured as a fiber laser.

27. (canceled)

28. The AM system of claim 15, wherein the foil material is a metal material having a thickness up to 1 mm.
